(19) United States
(12) Patent Application Publication
(10) Pub. No.: US 2010/0025048 A1
(43) Pub. Date: Feb. 4, 2010

(54) U-Shaped fiber optical cable assembly for use in a heated well and methods for in-stalling and using the assembly

(76) Inventors: Andre Franzen, Rijswijk (NL); Kari-Mikko Jääskeläinen, Houston, TX (US)

Correspondence Address: SHELL OIL COMPANY, P O BOX 2463, HOUSTON, TX, 772522463, US

(21) Appl. No.: 11/919,278

(22) PCT Filed: Apr. 25, 2005
(86) PCT No.: PCT/EP2006/061799

§ 371 Date: Oct. 25, 2007

(30) Foreign Application Priority Data
Apr. 27, 2005 (EP) 05103472.6

(51) Int. Cl. E21B 47/00; E21B 23/14; E21B 36/04; E21B 36/00; E21B 43/24; G02B 6/44

(52) U.S. Cl. 166/385; 166/302; 385/100

(57) ABSTRACT

A U-shaped fiber optical cable assembly (11, 21) is arranged in a heated well (1) such that a nose section (13, 23) comprising the bent U-shaped cable section (11C, 21C) is located near the toe (1 A) of the well where the ambient well temperature is lower than the temperature of an intermediate section of the well which is heated by steam injection, electrical heating and/or influx of heated hydrocarbon fluids from a heated section of the surrounding formation to a temperature above 200 degrees Celsius, thereby inhibiting the risk of hydrogen darkening of the bent U-shaped cable section. It is preferred to make the nose section of a glass solder, to arrange the U-shaped fiber optical cable assembly in an aluminium guide tube (22) sealed at its lower end with end cap (31), and to use a heat resistant fiber optical cable to further inhibit the risk of hydrogen darkening of the assembly.

### BACKGROUND OF THE INVENTION

The invention relates to a U-shaped fiber optical cable assembly of use in a heated well, to a method for installing the U-shaped fiber optical assembly in a well and to a method of using the assembly in a heated well.

In the oil and gas industry subsurface hydrocarbon containing formations are often heated by steam injection and/or electrical heating in order to reduce the viscosity of, vaporize, crack, and/or pyrolyse hydrocarbons such that less viscous, cracked, vaporized and/or pyrolysed hydrocarbons are generated that flow easily through the heated section of the formation to one or more hydrocarbon fluid production wells.

In such case heat may be injected via one or more dedicated heater wells via which steam is injected into the formation and/or in which electrical or other heaters are arranged and hydrocarbons may be produced via one or more dedicated production wells. Alternatively hydrocarbons may be produced via a steam soak method wherein steam is injected via one or more wells into the formation, whereupon the wells are closed to allow the steam to mobilize hydrocarbons within the formation, and the wells are subsequently reopened in to produce the mobilized hydrocarbons. Alternatively, steam or heat may be injected in a lower region of one or more wells and hydrocarbon fluids may be produced from an upper region of these wells.

In such case it is desirable to measure the temperature, pressure and/or other physical characteristics, such as the propagation of seismic waves, within the heated section of the formation in a reliable manner.

It is known from European patent application EP 0424120, Japanese patent application JP 2001124529A and from International patent application WO 00/49273 to use double ended U-shaped fiber optical assemblies in wells in order to measure the temperature, pressure and/or other physical characteristics within a well that may be heated. In such an assembly, light pulses are transmitted alternatingly into a first and second upper end of an U-shaped fiber optical cable which is suspended within a heater, production or other well and variations of the wavelength of the light backscattered from various points along the length of the optical fiber, in particular the Stokes and anti-Stokes peaks in the backscattered light spectrum, are measured in combination with the time of arrival of the backscattered light at the upper end of the cable in order to measure the temperature, pressure and/or other physical characteristics at various points along the length of the fiber optical cable.

The transmitted light pulses will weaken as they travel along the length of the fiber optical cable and the light backscattered at various points along the length of the cable may vary over time as the reflection of the light may be reduced as a result of darkening of the light guiding core of the optical fiber, in particular if the fiber is exposed to ingress of hydrogen.

By transmitting light pulses alternatingly into the first and the second end of the double ended U-shaped fiber optical cable, a pair of light reflections is generated at each location along the length of the well, which reflections are compared with each other in order to assess the effects of weakening of the light pulses as they travel along the length of the fiber optical cable and the effects of gradual darkening of the light guiding core of the fiber in the fiber optical cable, in particular the effects of hydrogen darkening.

It is known from U.S. Pat. No. 5,138,676 and from International patent application WO 2005/014976 to bend a glass fiber optical cable into a U-shaped configuration by heating a section of the cable to a temperature above 2000 degrees Celsius, whereupon the red hot section of the cable is stretched and simultaneously bent into a predetermined curved shape, whereupon the bent section is embedded in a nose section comprising a material, such as an epoxy resin, having a different light reflective index than the fiber optical cable. Such a nose section may have a width of less than 3 or 5 millimeters, so that the U-shaped cable can be easily inserted into a well.

A problem with the known U-shaped fiber optical cable assemblies is that in particular the section where the fiber optical cable is bent into a U-shape, the optical fiber core and/or surrounding nose section, are susceptible to darkening, in particular to hydrogen darkening, when the assembly is deployed in a heated well, in particular if the well is heated to a temperature above 200 or 300 degrees Celsius.

It is an object of the present invention to provide a U-shaped fiber optical cable assembly, which is configured for use in heated wells, such that darkening of the cable, in particular of the bent U-shaped section of the cable, is inhibited.

### SUMMARY OF THE INVENTION

In accordance with the invention there is provided a method of arranging a U-shaped fiber optical cable assembly in a heated well, the method comprising arranging a nose section comprising a bent U-shaped cable section near a toe of the well where the ambient well temperature is lower than the temperature of a heated intermediate section of the well.

It is preferred that the bent U-shaped cable section is embedded in a nose section comprising a glass solder having a lower index of reflection than the fiber optical cable, that the fiber optical cable is arranged in a aluminium protective tube such that the bent U-shaped cable section is located near a sealed lower end of the tube and that the aluminium protective tube containing the fiber optical cable is inserted into the well such that the sealed lower end of the tube is located near the toe of the well.

The ambient temperature near the toe of the well may be below 200 or 300 degrees Celsius and the temperature of the heated intermediate section of the well may be above 200 or 300 degrees Celsius.

Preferably, the fiber optical cable is a heat resistant cable, which is resistant to hydrogen darkening at a temperature of at least 200 degrees Celsius, more in particular at a temperature of at least 300 degrees Celsius.

The cable may comprise a purecore type hydrogen resistant fiber coated by a carbon, polyimide, ceramic and/or metal coating which is treated by a gas purging and/or a hydrogen getter technique.

In accordance with the invention there is also provided a fiber optical cable assembly comprising a U-shaped fiber optical cable which is arranged within a aluminium protective tube having a sealed lower end such that ingress of well fluids into the interior of the protective tube is prevented.

It is preferred that the fiber optical cable is a heat resistant cable with an optical fiber which is resistant to hydrogen darkening at a temperature of at least 200 degrees Celsius and that the bent U-shaped cable section is embedded in a nose section comprising a glass solder having a lower index of reflection than the fiber optical cable.

It is also preferred that the fiber optical cable is a purecore fiber coated by a carbon, polyimide, ceramic and/or metal coating which is treated by a gas purging and/or a hydrogen getter technique.

In accordance with the invention there is also provided a method of producing hydrocarbon fluids from a subsurface hydrocarbon containing formation, wherein a section of the formation is heated and traversed by a heated intermediate section of a well and the temperature, pressure and/or other physical parameters within the well are measured by measuring the wavelengths of backscattered light signals by means of a U-shaped fiber optical assembly comprising a nose section containing a bent U-shaped cable section, which is arranged near a toe of the well where the ambient well temperature is lower than the temperature of the heated intermediate section of the well.

These and other features, embodiment and advantages of the method and fiber optical cable assembly according to the invention are described in the accompanying claims, abstract and the following detailed description of a preferred embodiment in which reference is made to the accompanying drawings.

### BRIEF DESCRIPTION OF THE DRAWINGS

FIG. 1 depicts a heated well, in which a U-shaped fiber optical cable assembly is arranged in accordance with the invention, such that the U-folded section of the cable is located at the toe of the well, below the heated region of the well; and

FIG. 2 depicts a guide conduit containing a U-shaped fiber optical cable and a nose section in which the U-folded section of the cable is embedded.

### DETAILED DESCRIPTION OF PREFERRED EMBODIMENTS OF THE INVENTION

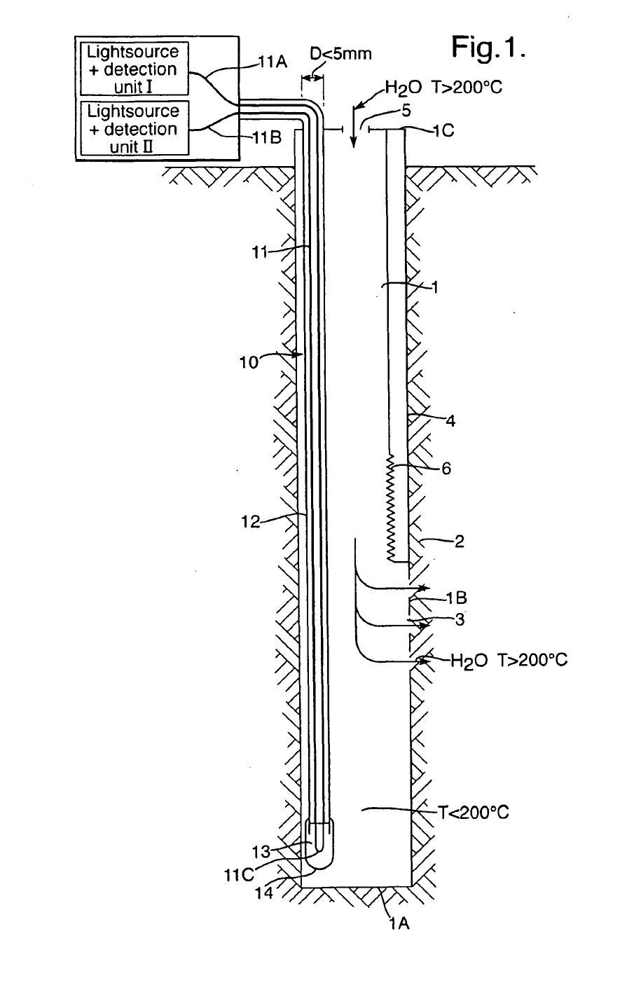

FIG. 1 depicts a heated well 1, which traverses a subsurface hydrocarbon containing formation 2 into which steam is injected via perforations 3 in the casing 4 in an intermediate section 1B of the well 1. The steam, represented in FIG. 1 as H₂O, has a temperature above 200 degrees Celsius and is injected via a steam injection port 5 at the wellhead 1C such that the steams flows from the wellhead 1C and the perforations 3 into the formation 2. Optionally, an electrical heating cable 6 is suspended in the well 1 in order to maintain the steam and/or surrounding formation 2 at the desired temperature above 200 degrees Celsius.

In order to monitor temperature, pressure and/or other physical characteristics within the interior of the heated well 1 a U-shaped fiber optical cable assembly 10 is suspended within the well 1. The assembly comprises a U-shaped fiber optical cable 11, which has a first and a second upper end 11A and 11B, via which alternatingly light pulses are transmitted into the cable 11 by means of a first and a second light source and detection unit I and 11. The cable 11 is inserted into an aluminium guide conduit 12 and comprises a U-folded lower section 11C, which is embedded in a nose section 13 comprising a glass solder or other material having a lower light reflective index than the fiber optical cable 11. The nose section 13 is arranged within an aluminium cap 14 which is welded or otherwise sealingly secured to the lower end of the guide conduit 12. The U-folded lower section 11C is particularly susceptible to hydrogen darkening and is therefore arranged near the toe 1A of the well where the temperature is below 200 degrees Celsius, whereas the temperature of the heated intermediate section 1B may be above 200 or 300 degrees Celsius.

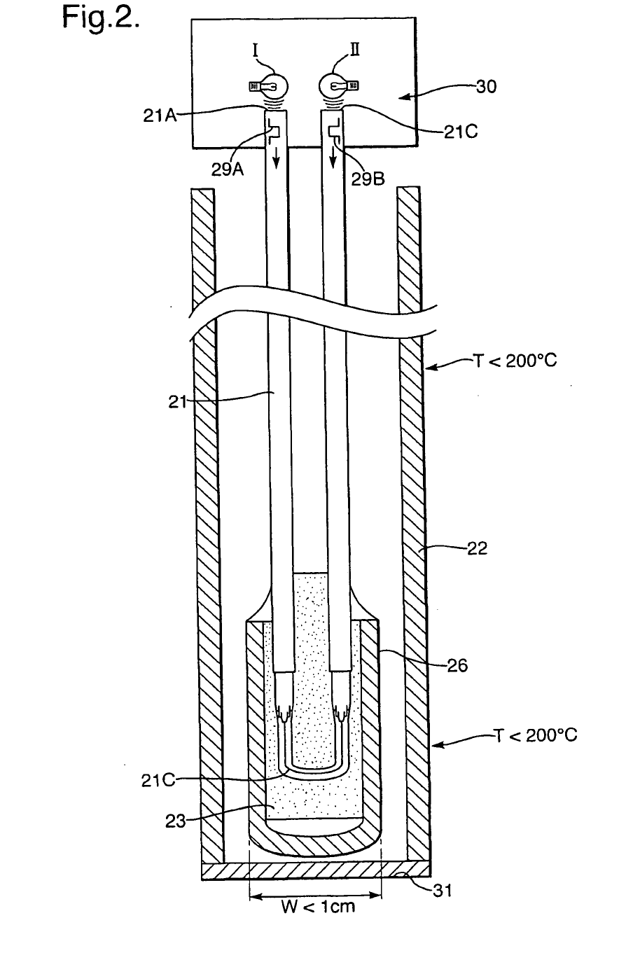

FIG. 2 depicts an alternative embodiment of the aluminium guide conduit 22, which contains a double ended, U-shaped, fiber optical cable 21 with an U-folded lower section 21C embedded in a nose section 23. The U-folded lower section portion 22C interconnects two elongate substantially straight sections the optical fiber 21. The U-folded lower section 21C is heated to a temperature above 2000 degrees Celsius and stretched during the bending process, whereupon the red-hot bent U-folded cable section is embedded in the nose section 23 which is made of a material having a lower index of reflection than the U-folded nose portion 21C of the optical fiber 21, such as a glass solder, thereby creating optical continuity in the U-folded nose portion 21C.

A suitable method for bending a fiber optical cable into a U-shaped configuration is disclosed in U.S. Pat. No. 5,138,676 and in International patent application WO 2005/014976.

The nose section 23 comprises an impact resistant shield 26 and has a generally cylindrical shape. The outer width W of the shield 26 surrounding the nose section 23 may be less than 1 cm, preferably less than 5, and more preferably less than 3 mm. The aluminium guide conduit 1 may have an internal width less than 1 cm, preferably less than 5 mm.

The small internal and external width of the guide conduit 12 generate a distributed sensing assembly which is compact and non-intrusive and which can be easily inserted into narrow passageways, such as hydraulic power and control conduits, in an underground well for the production of hydrocarbon fluids, such as crude oil and/or gas and/or for heat or steam injection.

The elongate sections of the fiber optical cable 21 above the nose section 23 comprise a pair of upper ends 21A and 21B that are connected to light pulse generation and receiving units I and II which comprise a pair of light sources, which are configured to transmit alternatingly or simultaneously pulsed wave laser light signals 29A and 29B via the upper ends 21A and 21B into the fiber optical cable 21. The units I and II are contained in a reference chamber 30 in which the temperature and/or pressure are monitored by a calibrated thermometer and/or pressure gauge to provide a region in which the upper parts of the elongate sections 4A and 4B are exposed to a known temperature and/or pressure.

By using a double ended fiber optical temperature and/or pressure sensing cable 21 light pulses 29A and 29B can be directed in both ways though the cable 21, which enables to compensate for any attenuation of the light pulses 29A and 29B as they travel along the length of the fiber optical cable 21 and which eliminates the need for the use of a downhole pressure and/or temperature reference sensor, which is required for the conventional single ended distributed pressure and/or temperature sensing (DPS/DTS) fiber optical assemblies.

In the embodiment shown in FIG. 2 the fiber optical cable 21 is freely suspended within an aluminium guide conduit 22 that is sealed at its lower end by an aluminium end cap 31. The use of an aluminium guide conduit 22 and end cap 31 is preferred, because aluminium provides a better barrier against hydrogen ingress from the well bore than other materials, such as stainless steel.

The optical fiber 11 and 21 as depicted in FIGS. 1 and 2 preferably is a heat resistant optical fiber, such as a purecore fiber coated by a carbon coating, which is treated by a gas purging and/or a hydrogen getter technique.

The impact of hydrogen and the darkening effects in optical fibers is widely known. The reversible and non-reversible effects are described in the paper “Investigation on hydrogen induced effects on optical cables and possible countermeasures”, published in CSELT Technical reports—Vol. XIII—No. 5—October 1985 by P. Anelli et al, in which paper possible counter measures are proposed, such as eliminating the Phosphorous dopant.

Detailed studies on hydrogen darkening are described in the article “Interaction of Hydrogen and Deuterium in Silica fibers: A Review” published in the Journal Of Lightwave Technology, Vol. LT-5, No. 5, May 1987 by J. Stone. This article describes the impact and location of the hydrogen induced absorption peaks and possible hydrogen sources within the cable.

The paper “Development of Fiber Optic Cables for Permanent Geothermal Wellbore Deployment” published in the proceedings of the twenty-sixth Workshop on Geothermal Reservoir Engineering Stanford University, Stanford, California, Jan. 29-31, 2001, SGP-TR-168, by Randy Norman et al. of Sandia National Laboratories highlights the impact of Germanium and Phosphorous dopants in the optical fibre core and propose to add Flourine to the fiber to mitigate the hydrogen induced effects.

Gettering technology has progressed in the last few years, and is described in U.S. Pat. No. 5,703,378 and U.S. Pat. No. 5,837,158 and in International patent application WO99/48125. Current gettering technology has potential for applications above 300 degrees Celsius.

It is well known from other industries outside Oil & Gas to purge cables with suitable gases to reduce and mitigate the hydrogen effects. This is described in the paper “Hydrogen in optical cables” published in the IEE Proceedings, volume 132, Pt. J. No. 3, June 1985, by R. S. Ashpole et al.

It is preferred to combine the various known techniques for inhibiting hydrogen darkening such that accumulated and/or synergetic effects are obtained and a durable and robust fiber optical sensor assembly is provided which can be inserted in a heated well to provide temperature and/or other measurements in a reliable manner.

Accordingly it is preferred to use a purecore fiber that is substantially free of Phosphorus and/or Germanium dopants and that is coated by a carbon, polyimide, ceramic and/or metal coating which is treated by a gas purging and a hydrogen getter technique.

The U-folded cable section 11C, which is embedded in the nose section 13, is particularly sensitive to hydrogen darkening. Therefore it is preferred to embed the U-folded cable section 11C in a nose section 13 comprising a glass solder, which makes the U-folded cable section 11C less prone to hydrogen darkening than an epoxy resin and to arrange the nose section 13, as depicted in FIG. 1, near the toe 1A of the well 1, where the ambient well temperature is lower than in the heated intermediate section 1B of the well that is located between the toe 1A of the well and the wellhead 1C.

It will be understood that the heated well 1 may have vertical, tilted and/or horizontal sections, or may have a J-shape, and that the arrangement near the toe 1A of the well implies that the heated section 1B of the well is located between the wellhead 1C and the location where the nose section 13 comprising the U-folded fiber optical cable section 11C is arranged and that the toe 1A of the well 1 may be located at a considerable vertical and/or horizontal distance from the nose section 13.

1. A method of arranging a U-shaped fiber optical cable assembly in a well, the method comprising:
arranging a nose section comprising a bent U-shaped cable section near a toe of the well where the ambient well temperature is lower than the temperature of a heated intermediate section of the well;
wherein the fiber optical cable is arranged in an aluminium protective tube such that the bent U-shaped cable section is located near a sealed lower end of the tube and the aluminium protective tube containing the fiber optical cable is inserted into the well such that the sealed lower end of the tube is located near the toe of the well.

2. The method of claim 1, wherein the bent U-shaped cable section is embedded in a nose section comprising a glass solder having a lower index of reflection than the fiber optical cable.

3. The method of claim 1, wherein the aluminium protective tube has an inner width less than 5 millimeters and the nose section comprising the bent U-shaped cable section protrudes from the lower end of the aluminium protective tube and is arranged within a cup-shaped aluminium cap which is secured in a fluid tight manner to the aluminium tube such that ingress of well fluids into the interior of the protective tube is prevented.

4. The method of claim 1, wherein the ambient temperature near the toe of the well is below 200 degrees Celsius and the temperature of the heated intermediate section of the well is above 200 degrees Celsius.

5. The method of claim 1, wherein the ambient temperature near the toe of the well is below 300 degrees Celsius and the temperature of the heated intermediate section is above 300 degrees Celsius.

6. The method of claim 4, wherein the fiber optical cable is a heat resistant cable which is resistant to hydrogen darkening at a temperature of at least 200 degrees Celsius, more in particular at a temperature of at least 300 degrees Celsius.

7. The method of claim 6, wherein the cable includes a coating selected from the group consisting of carbon coatings, polyamide coatings and ceramic coatings.

8. (canceled)

9. (canceled)

10. The method of claim 6, wherein the cable includes a metal coating.

11. The method of claim 5, wherein the fiber optical cable is a purecore type hydrogen resistant fiber with a light guiding core that is substantially free of Phosphorus and/or Germanium dopants.

12. The method of claim 6, wherein the fiber optical cable is treated by a gas purging technique.

13. The method of claim 6, wherein the fiber optical cable is treated by a hydrogen getter technique.

14. The method of claim 6, wherein the fiber optical cable is a purecore type hydrogen resistant fiber coated by a carbon, polyimide, ceramic and/or metal coating which is treated by a gas purging and/or a hydrogen getter technique.

15. The method of claim 1, wherein at least part of the U-shaped fiber optical cable assembly is inserted in an aluminium protective tube having a sealed lower end such that ingress of well fluids into the interior of the protective tube is prevented.

16. The method of claim 1, wherein the intermediate section of the well is heated by steam injection and/or electrical heating after installation of the U-shaped fiber optical cable assembly in the well and wherein the assembly is used to monitor temperature, pressure and/or other physical parameters along at least part of the length of the well.

17. A fiber optical cable assembly comprising a U-shaped fiber optical cable which is arranged within an aluminium protective tube having a sealed lower end such that ingress of well fluids into the interior of the protective tube is prevented.

18. The fiber optical cable assembly of claim 17, wherein the fiber optical cable is a heat resistant cable with an optical fiber which is resistant to hydrogen darkening at a temperature of at least 200 degrees Celsius and the bent U-shaped cable section is embedded in a nose section comprising a glass solder having a lower index of reflection than the fiber optical cable.

19. The fiber optical cable assembly of claim 18, wherein the fiber optical cable is a purecore fiber coated by a carbon, polyimide, ceramic and/or metal coating which is treated by a gas purging and/or a hydrogen getter technique.

20. A method of producing hydrocarbon fluids from a subsurface hydrocarbon containing formation, wherein a section of the formation is heated and traversed by a heated intermediate section of a well and the temperature, pressure and/or other physical parameters within the well are measured by measuring the wavelengths of backscattered light signals by means of a U-shaped fiber optical assembly comprising a nose section containing a bent U-shaped cable section, which is arranged near a toe of the well where the ambient well temperature is lower than the temperature of the heated intermediate section of the well;
wherein the fiber optical cable is arranged in an aluminium protective tube such that the bent U-shaped cable section is located near a sealed lower end of the tube and the aluminium protective tube containing the fiber optical cable is inserted into the well such that the sealed lower end of the tube is located near the toe of the well.

21. The method of claim 20, wherein the temperature of the heated intermediate section of the well is above 200 degrees Celsius and the temperature near the toe of the well is below 200 degrees Celsius.

22. The method of claim 20, wherein the temperature of the heated intermediate section of the well is above 300 degrees Celsius and the temperature near the toe of the well is below 300 degrees Celsius.
